(19) United States
(12) Patent Application Publication
(10) Pub. No.: US 2004/0199647 A1
(43) Pub. Date: Oct. 7, 2004

(54) Method and system for preventing unauthorized action in an application and network management software environment

(76) Inventors: Guruprasad Ramarao, San Jose, CA (US); Amit A. Raikar, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/360,883

(22) Filed: Feb. 6, 2003

(51) Int. Cl. G06F 15/16

(52) U.S. Cl. 709/229

(57) ABSTRACT

In one embodiment, the present invention recites an Application and Network Management software (ANMS) environment in which a message requesting an action is received from an ANMS sending node. Upon determining that the action is not permitted in the ANMS environment, the action is prevented from occurring.

### TECHNICAL FIELD

The present claimed invention relates to computer network management. More specifically, the present claimed invention relates to the management of Application and Network Management software environments.

### BACKGROUND ART

Application and Network Management software (ANMS) is used to provide centralized user, software, and system administration in heterogeneous network environments. ANMS systems provide a common interface for controlling network resource management and applications management. For example, ANMS systems can be used to map the network topology, manage data storage resources, and for re-routing network traffic around downed links or to balance the load on the network. ANMS can also be used to control network devices and for network diagnostic functions such as traffic analysis. Applications management functions can include data recovery, business data analysis, multi-platform mediation, operating system management, management of help desk and customer service processes, etc.

ANMS systems provide a greater level of functionality than was previously realized by enterprises using separate network management and applications management software. Thus, ANMS systems are particularly useful for performing Root Cause Analysis of failed services. For example, normally a service includes both network (e.g., hardware) and application (e.g., software) component. Using separate network management and application management software, it is difficult to form a correlation between a hardware fault and a software fault which necessary to perform an accurate analysis. However, because ANMS systems can gather data from the hardware and software to better form a correlation of events.

FIG. 1 is a block diagram of an exemplary prior art computer network upon which embodiments of the present invention may be practiced. In FIG. 1, a plurality of client nodes (e.g., clients 101, and 102) are communicatively coupled with a server node 150 via a client node 105. Similarly, client nodes 103 and 104 are communicatively coupled with server 150 via client node 106. An ANMS agent resides upon each of the client nodes and on server node 150. In an ANMS system, the software agents provide the functionality for managing the ANMS environment. For example the ANMS agent residing upon client 101 can gather information and send data to server 150 used for performance monitoring of client 101. Additionally, the agents are used to perform actions on behalf of the server. For example, the server can use the agent to re-configure a client node in order to re-route communications around a downed node.

The agents can also be used to invoke an action upon a remote node. For example, the agent on client 101 may send a request that causes an action to be performed by the agent on client 104. Typically, the agents residing on the client nodes do not communicate directly. Instead, the requests are sent to the server node and the server then tells receiving client node what action to perform. Requested actions can either be explicit actions or implicit actions. Explicit actions are detailed instructions that state a particular action that is to be performed by the agent of a particular node. For example, in a host based Intrusion Detection System (IDS), the agent on the IDS server may send instructions telling the server to enable host based IDS on a remote node. The IDS server sends instructions to the agent on the remote node that then enables the host based IDS on the remote node. Additionally, an agent can take an explicit action on itself without accessing the ANMS server. For example, if a log file becomes full, the agent can empty the log file without sending a message to the server.

Implicit actions are not explicit commands, but are instead based upon data which the ANMS server then acts upon. For example, client 101 may send data to server 150 that indicates that it is not receiving any traffic from its subnet. Server 150 correlates that data with the current state of the network and determines that a proxy server (e.g., client 105) is not sending data. Server 150 can then send instructions, to be performed by the ANMS agent on client 105, to reconfigure the proxy server.

Typically, the actions performed by agents are configured using configuration files on the agent. The configuration files match an event to a particular configuration condition. When that condition occurs, if an action is associated with that particular condition in the configuration file, that action is performed. Usually, the configuration files are sent to the client agents from the server. However, these files can also be manually configured. This can create a situation in which non-privileged users can implicitly initiate unauthorized actions on other nodes in the network.

Many ANMS agent frameworks do not make a distinction between a non-privileged action and a privileged action. Thus, a non-privileged user who is familiar with ANMS systems can exploit this vulnerability by reconfiguring the agent templates to initiate privileged actions on the system. This approach may be used to cause the server node to initiate unauthorized, with respect to the user, actions on the server itself or on other client nodes in the system. For example, a log file may be configured so that when a given condition is met, data at a remote node is accessed. However, a user could manually reconfigure the log file so that when that condition is met, a directory in the server is automatically erased instead.

Unless a system administrator is aware of this vulnerability, they may assume that the ANMS system provides adequate security measures without the need for specific configuration. However, ANMS systems are designed to integrate a variety of software applications and thus necessarily provide a more generic configuration of agent templates than may be desired in some implementations. Thus, some ANMS systems may not provide a desired level of security, especially when deployed in multi-trust domains. More specifically, granular authorization of remote action invocations from one node to another are not addressed by current ANMS systems. As a result, all nodes on the network are either assumed to be trusted, which implies that the templates have not been modified, or untrusted, which typically results in the blocking of all remote actions between the ANMS nodes.

### SUMMARY OF THE INVENTION

In one embodiment, the present invention recites an Application and Network Management software (ANMS) environment in which a message requesting an action is received from an ANMS sending node. Upon determining that the action is not permitted in the ANMS environment, the action is prevented from occurring.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary computer system upon which embodiments of the present invention may be practiced.

FIG. 2 is a block diagram of an computer network upon which embodiments of the present invention may be practiced.

FIG. 3 is a flowchart of a method for preventing unauthorized action in an exemplary ANMS environment in accordance with embodiments of the present invention.

FIGS. 4A and 4B are a block diagrams of communication interfaces for an exemplary Application and Network Management software (ANMS) client and ANMS server respectively in accordance with embodiments of the present invention.

FIGS. 5A, 5B, and 5C are a flowchart, showing in greater detail, a method for preventing unauthorized action in an ANMS environment in accordance with embodiments of the present invention.

### MODE FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “determining,” “preventing,” “comparing,” “sending,” “altering,” “generating,” “redirecting,” “isolating,” “accessing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

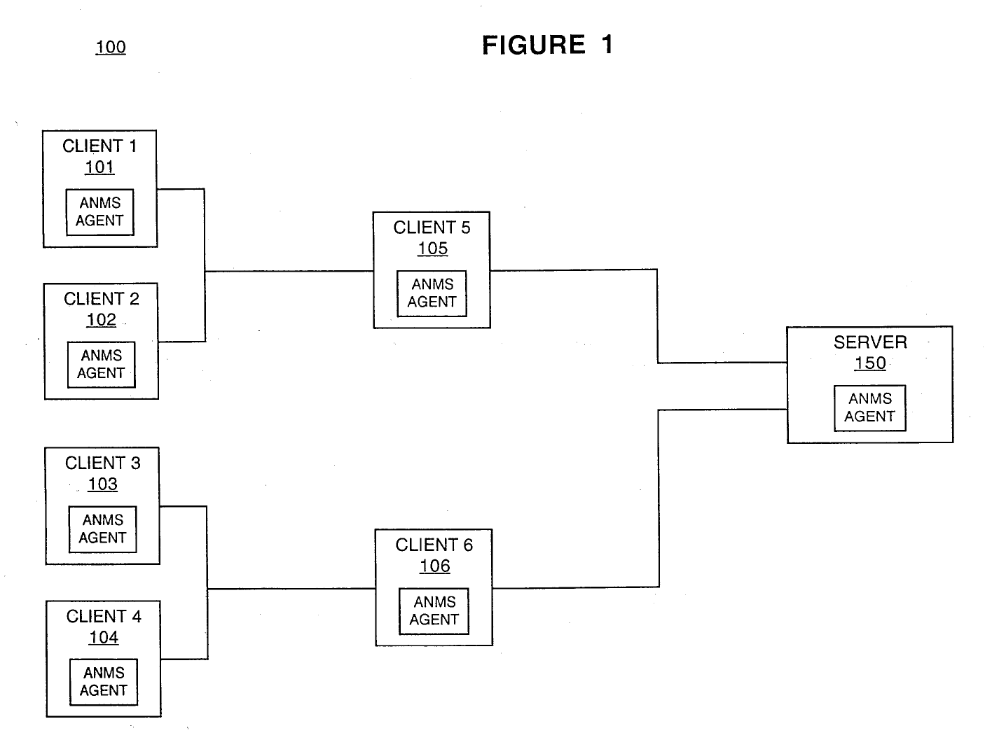

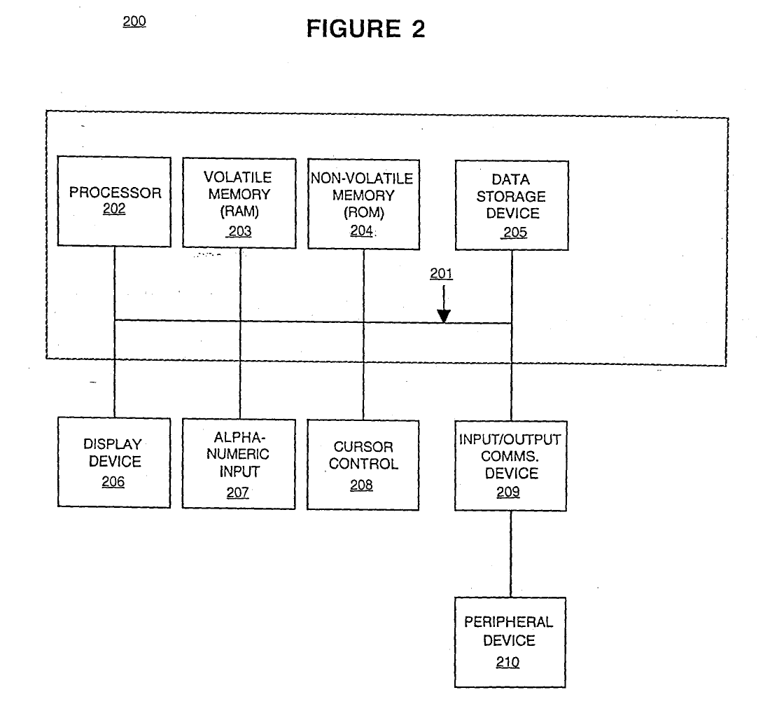

With reference to FIG. 2, portions of the present invention are comprised of computer-readable and computer-executable instructions that reside, for example, in computer system 200 which is used as a part of a computer network (e.g., network 100 of FIG. 1). It is appreciated that computer system 200 of FIG. 2 is exemplary only and that the present invention can operate within a number of different computer systems including general-purpose computer systems, embedded computer systems, laptop computer systems, hand-held computer systems, and stand-alone computer systems.

In the present embodiment, computer system 200 includes an address/data bus 201 for conveying digital information between the various components, a central processor unit (CPU) 202 for processing the digital information and instructions, a volatile main memory 203 comprised of volatile random access memory (RAM) for storing the digital information and instructions, and a non-volatile read only memory (ROM) 204 for storing information and instructions of a more permanent nature. In addition, computer system 200 may also include a data storage device 205 (e.g., a magnetic, optical, floppy, or tape drive or the like) for storing vast amounts of data. It should be noted that the software program for preventing unauthorized action in an Application and Network Management software environment of the present invention can be stored either in volatile memory 203, data storage device 205, or in an external storage device (not shown).

Devices which are optionally coupled to computer system 200 include a display device 206 for displaying information to a computer user, an alpha-numeric input device 207 (e.g., a keyboard), and a cursor control device 208 (e.g., mouse, trackball, light pen, etc.) for inputting data, selections, updates, etc. Computer system 200 can also include a mechanism for emitting an audible signal (not shown).

Returning still to FIG. 2, optional display device 206 of FIG. 2 may be a liquid crystal device, cathode ray tube, or other display device suitable for creating graphic images and alpha-numeric characters recognizable to a user. Optional cursor control device 208 allows the computer user to dynamically signal the two dimensional movement of a visible symbol (cursor) on a display screen of display device 206. Many implementations of cursor control device 208 are known in the art including a trackball, mouse, touch pad, joystick, or special keys on alpha-numeric input 207 capable of signaling movement of a given direction or manner displacement. Alternatively, it will be appreciated that a cursor can be directed an/or activated via input from alpha-numeric input 207 using special keys and key sequence commands. Alternatively, the cursor may be directed and/or activated via input from a number of specially adapted cursor directing devices.

Furthermore, computer system 200 can include an input/output (I/O) signal unit (e.g., interface) 209 for interfacing with a peripheral device 210 (e.g., a computer network, modem, mass storage device, etc.). Accordingly, computer system 200 may be coupled in a network, such as a client/server environment, whereby a number of clients (e.g., personal computers, workstations, portable computers, minicomputers, terminals, etc.) are used to run processes for performing desired tasks (e.g., “receiving,” “determining,” “preventing,” “comparing,” “sending,” “altering,” “generating,” “redirecting,” “isolating,” “accessing,” etc.). In particular, computer system 200 can be coupled in a system for preventing unauthorized action in an Application and Network Management software environment.

In one embodiment, the present invention is implemented upon the OpenView Operations (OVO) product which is commercially available from Hewlett-Packard Company of Palo Alto, Calif. For purposes of clarity, the present invention will refer an OVO operating environment specifically. While the present invention recites an OVO environment specifically, embodiments of the present invention are well suited to be implemented upon other ANMS systems as well. Many ANMS systems come as a generic solution due to the variety to software applications and network management applications they may be required to manage. Therefore software plug-ins are routinely used provide a greater level of functionality for particular applications used by an enterprise. Embodiments of the present invention are well suited to be implemented either as a software plug-in for a legacy ANMS system or as a built-in functionality of a new ANMS software installation.

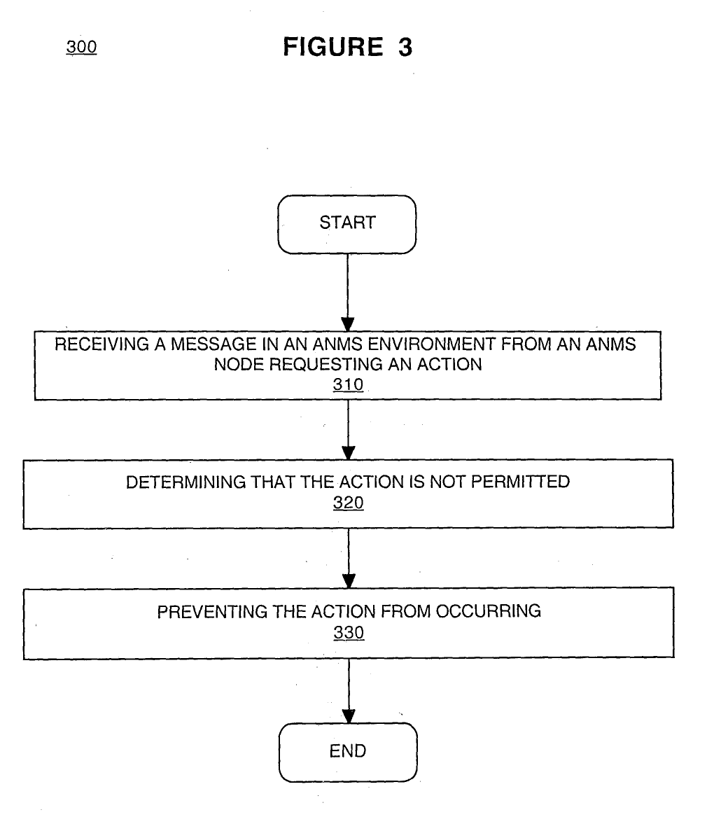

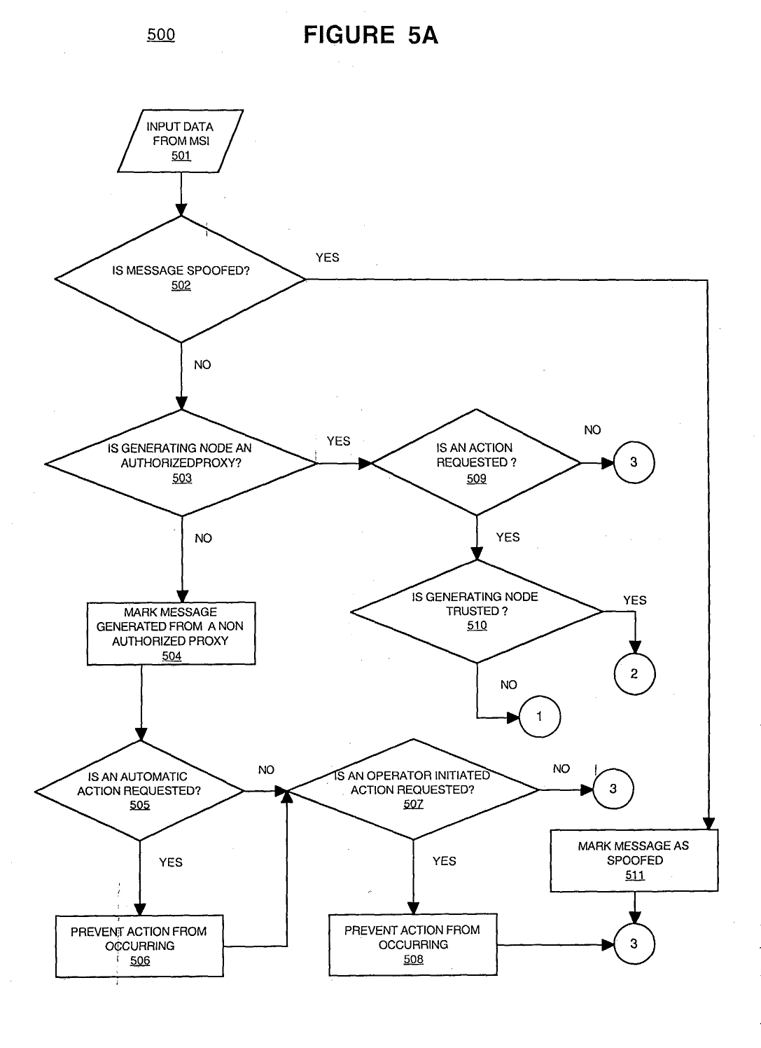

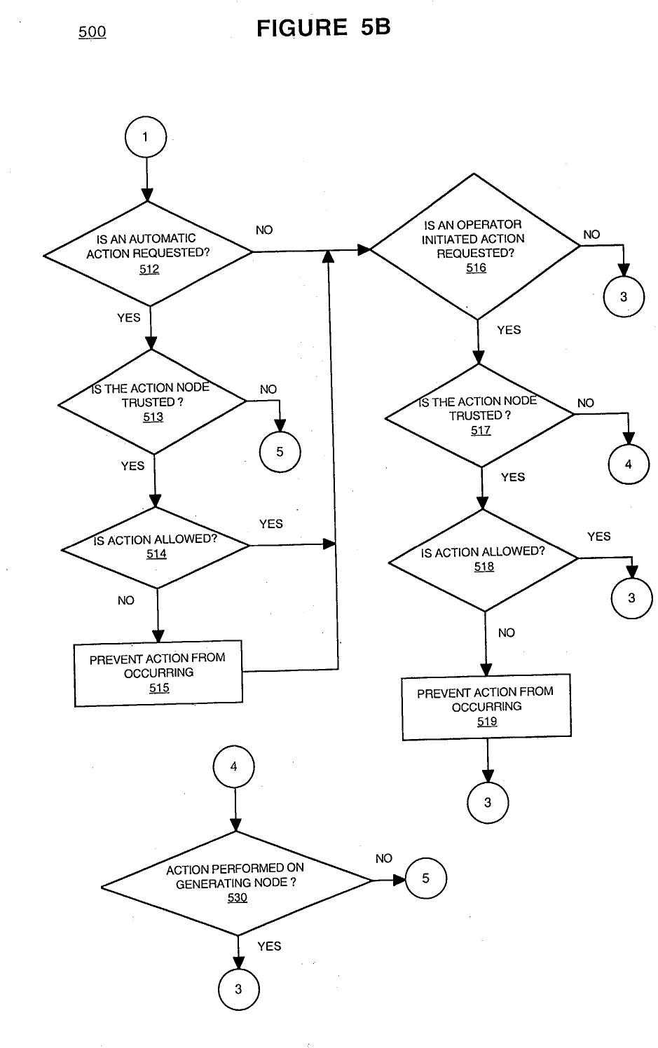

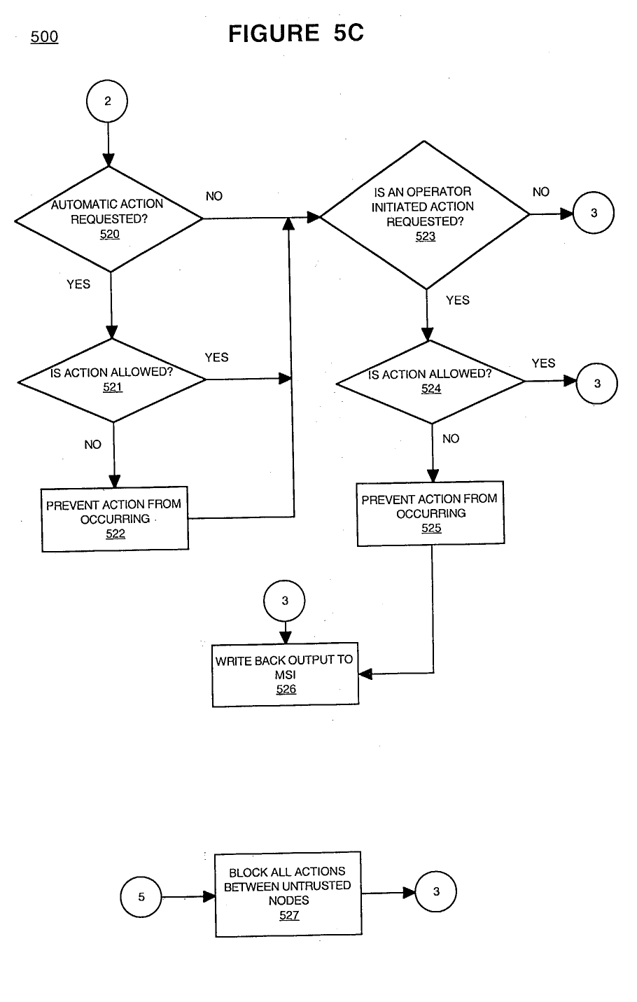

FIG. 3 is a flowchart of a method for preventing unauthorized action in an exemplary ANMS environment in accordance with embodiments of the present invention. In step 310 of FIG. 3, a message is received in an ANMS environment from an ANMS node requesting an action. This step corresponds with 501 of FIG. 5A. In one embodiment, the Message Stream Interface (MSI) provided by OVO is used to intercept incoming messages before getting processed by the OVO server to the OVO agent. The invention application could also be similarly implemented to intercept outgoing messages before getting processed by the OVO server from the OVO agent.

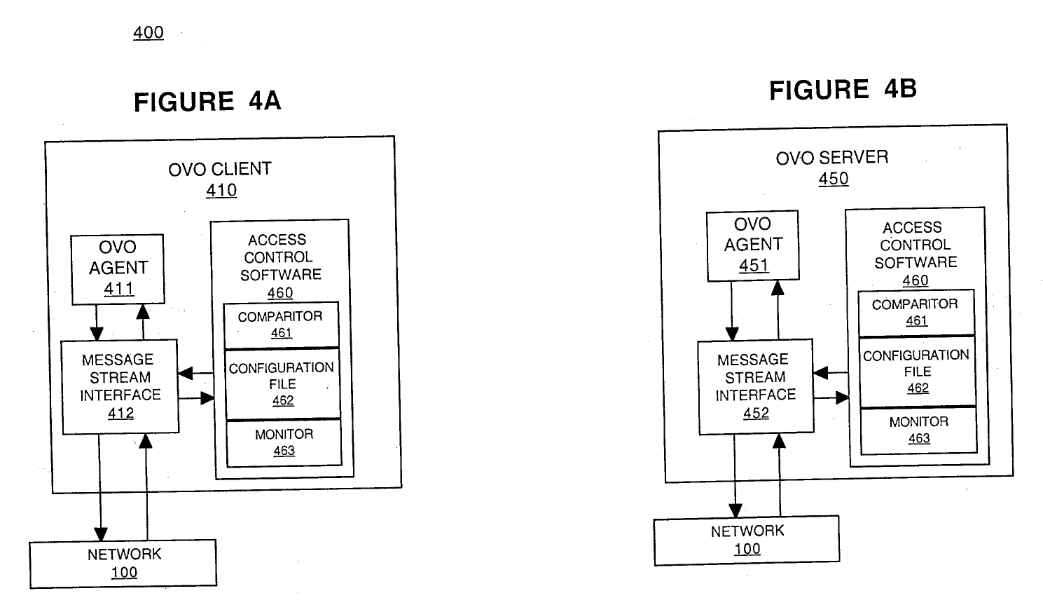

FIGS. 4A and 4B are a block diagrams of communication interfaces for an exemplary OVO client and OVO server respectively in accordance with embodiments of the present invention. In FIG. 4A, an OVO agent 411 resident on, for example, OVO client 410 is communicatively coupled with network 100 via message interface 412. Access control software 460 of the present invention is also communicatively coupled with message stream interface 412. In embodiments of the present invention, before OVO client 410 invokes an action via server 450, the message conveying the invoked action is first diverted to access control software 460.

In embodiments of the present invention, access control software 460 comprises a configuration file 462 that lists the privileges that each agent in the OVO environment are permitted. Access control software 460 compares the invoked action with the configuration file listing actions that OVO client 410 is authorized to invoke using a comparitor 461. If the action is permitted, the message is returned to message stream interface 412 so that it can be sent to OVO server 450. A monitor template 463 is implemented that monitors the existence of the application process of comparitor 462. Additionally, monitor 463 monitors the integrity of configuration file 462. If the integrity of configuration file 462 becomes compromised or comparitor 461 becomes unavailable, monitor 463 blocks any actions being invoked from occurring and automatically attempts to restart access control software 460. Additionally, monitor 463 can initiate sending an alert to a security message group indicating that the access control software 460 is not available on that particular node.

In a similar manner, a message conveying an action to be performed by the OVO agent 411 is first diverted to access control software 460 before being acted upon. In an OVO environment, invoked actions are either automatic actions or operator initiated actions. An automatic operation is one that is performed automatically by the receiving agent when the message conveying the invoked action is received. The other type of operation that may be performed is an operator initiated action, in which some confirmation from a user is required before the action is performed by the OVO agent. For example, a pop-up window may be displayed asking the user if they want the action to be performed. The user can either elect to proceed with the action or not. In the present invention, the invoked action is compared to the configuration file 462 of access control software 460 listing actions that are authorized to be invoked upon OVO client 410. If the invoked action is listed in the configuration file, the message conveying the invoked action is returned to message stream interface 411 so that OVO agent 411 can perform the invoked action.

In FIG. 4B, an OVO agent 451 is resident on OVO server 450 and is communicatively coupled with network 100 via message interface 452. access control software 460 of the present invention is communicatively couple with message stream interface 452. In embodiments of the present invention, before an action is invoked by OVO server 450, the message conveying the invoked action is first diverted to access control software 460. The invoked action is compared with the configuration file listing actions that are permitted to be invoked upon network 100. If the action is permitted, the message conveying the invoked action is returned to message stream interface 452 and sent to the appropriate OVO agent in the system. In a similar manner, a message conveying an action to be performed by OVO server 450 is first diverted to access control software 460 before being acted upon. If the action is permitted, the message conveying the invoked action is returned to message stream interface 452 an acted upon by OVO agent 451.

Access control software 460 enforces restrictions on the remote actions that can be initiated from one managed OVO node onto another managed OVO node and upon local operator-initiated actions as well. In one embodiment of the present invention, access control software 460 is implemented at the OVO server level. As described above, when an OVO agent attempts to invoke a remote action by another OVO agent in the system. Additionally, all messages invoking a local operator initiated action are first routed via OVO server 450. When access control software 460 is applied at the OVO server 450 it can enforce restrictions on the types of remote actions that are permitted in the ANMS system, which nodes in the system are permitted to invoke certain actions, and which managed nodes in the system these actions can be invoked upon. Additionally, access control software 460 may be implemented upon each client node in the OVO environment. This is advantageous when access control software is deployed in larger computer networks where also the performance of the OVO server could be affected owing to the filtering action of the access control software that is deployed at the server. Implementing the present invention at the client node level facilitates preventing unauthorized actions from being invoked upon another node in the OVO environment, as well as local automatic and operator initiated actions upon the client node itself. The enforcement of restrictions can be implemented at the level of individual nodes, at the level of node groups, or to the entire ANMS system. Additionally, the enforcement can be made granular in terms of what exact remote actions can be initiated. The parameters to those remote actions can be set to be validated, if they can be compared against any local OVO environment variable, string matched, or just configured as variable. In one embodiment, only the actions that are defined in the configuration file of access control software 460 are allowed, all other actions are prevented from occurring.

In embodiments of the present invention, the configuration file can either be written in a proprietary if it is intended to be a stand-alone application, or be written so as to conform to an XML Schema. If there is a centralized Policy Manager that is intended to enforce centrally defined policy based restrictions on the type of remote actions, writing the configuration in XML would help in integrating the present invention with the overall Policy based Security architecture of a solution. It is appreciated, however, that the present invention is well suited to being written in a variety of languages.

The configuration file of access control software 460 can be refreshed at runtime without restarting the application, OVO server, or agent 451. Access control software 460 is implemented so as to be running whenever OVO server 450 or agent 451 is running (by synchronizing it with the ovstart command) in embodiments of the present invention.

As described above, access control software 460 may also be implemented at the OVO client level in embodiments of the present invention. This also facilitates preventing a user from getting around enforcement restrictions by spoofing the OVO server and directly invoking remote actions on a managed node from a remote node. Spoofing refers to changing the message header to make it appear that a message originated from a different source. By allowing enforcement at the OVO client node level, each OVO client can be used to enforce the restrictions on remote actions that can be initiated on itself from another managed node or the OVO server. Additionally the OVO client can also enforce the restrictions on what remote actions it can initiate against other managed nodes in the OVO environment and thereby avoid the possibility of being used as a compromised node that could be used to launch attacks against any other managed node managed by the same OVO server. Using this invention at the managed node level would also facilitate that the performance of the OVO server 450 (in the case of large managed domains) does not get severely affected owing to the filtering action of the access control software that is deployed at the server. In this case, the invention enforcement at the server level would serve as a second line of defense against unauthorized action.

Referring now to step 320 of FIG. 3, access control software 460 determines that the requested action is not permitted. Referring now to FIG. 5A, after data in input from the message stream interface (MSI) at step 501 a logical step is performed to determine whether the message is spoofed. As described above, spoofing is a type of network attack in which the header of a message is changed to make it appear that the message originated from a different source. Current implementations of the OVO software perform this operation to determine whether the message has been spoofed. If the message has been spoofed, further processing of the message is not necessary as the message is not acted upon and flowchart 500 continues to step 511. If the message has not been spoofed, flowchart 500 continues to step 503.

At step 503 of flowchart 500, a logical operation is performed to determine whether the OVO node generating the message invoking an action is an authorized proxy node. In an OVO environment, on client node can act as a proxy for another client node. For example, referring to FIG. 1, client 105 can act as a proxy for clients 101 and 102 and send messages to server 450 in their behalf. Thus, a user at client 105 can send a message to server 450 saying that they are proxying a message for client 101 that could cause server 450 to invoke an action on client 101. In embodiments of the present invention, access control software 460 compares the identity of the agent from which the message was generated with the configuration file listing authorized proxy nodes in the OVO environment. If the generating node is not listed as an authorized proxy, the message is not acted upon and flowchart 500 continues to step 504. In other words, if the sending node is not listed on the configuration file of access control software 460, any action it requests will be prevented from occurring. If the generating node is an authorized proxy, flowchart 500 continues to step 509.

At step 504 of flowchart 500, the message is marked as having been generated by a non-authorized proxy. In embodiments of the present invention, actions requested in spoofed messages are prevented from occurring. Thus, in embodiments of the present invention, the message is altered to indicate that the message is a spoofed message. In embodiments of the present invention, the flags in the OPCDATA_DATA_INFO field are set to:

OPC_DATA_SENDER_ADDR_MISMATCH

& OPC _DATA_AUTHENTICATION _FAILED.

Additionally, in embodiments of the present invention, additional information is appended to the message to automatically initiate a security alert if a message is received from a non-authorized proxy. Additionally, the message can be automatically routed to an Intrusion Detection System (IDS) server to trigger an intrusion alert. From step 504, flowchart 500 continues to step 505.

At step 505, a logical operation is performed to determine whether an automatic action is requested. An automatic operation is one that is performed automatically by the receiving agent. The other type of operation that may be performed is an operator initiated action, in which some confirmation from a user is required before the action is performed by the OVO agent. For example, a pop-up window may be displayed asking the user if they want the action to be performed. The user can either elect to proceed with the action or not. In step 505, if an automatic action is being requested, flowchart 500 proceeds to step 506. If no automatic action is being requested, flowchart 500 proceeds to step 507.

At step 506 of flowchart 500, the automatic action is disabled to prevent it from occurring. In some ANMS systems, even if the action is marked as being a spoofed message, an automatic action may be invoked if the configuration of the template matches an event monitored by an agent. By disabling the automatic action at step 506 this is prevented from occurring. In embodiments of the present invention, the message is appended with data that disables the invoked action. For example, data can be appended to the message indicating that the automatic action is to be discarded or the auto action string can be set to ″″. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of actions in response to detecting requests for unauthorized actions. When the automatic action has been disabled, flowchart 500 then proceeds to step 507.

At step 507, a logical operation is performed to determine whether an operator initiated action is being requested. In an OVO environment, a single message may request both an automatic action and an operator initiated action. Therefore, it is necessary to check for both types of actions in order to fully prevent unauthorized actions from being initiated by authorized users. If the message does not request an operator initiated action, flowchart 500 proceeds to step 526 where the message is returned to the message stream interface. If there is an operator initiated action, flowchart 500 proceeds to step 508.

At step 508, the operator initiated action is disabled. As was stated above, because it has been determined that the message was generated by an unauthorized proxy node, all actions requested by the message will be disabled. In embodiments of the present invention, the message is appended with data that disables the operator initiated action. For example, data may be appended that indicates that the operator initiated action is to be discarded, or the operator-init action string may be set to ″″. At this point, all actions requested by the message have been disabled and the message has been marked as a spoofed message. Additionally, the message has been marked to initiate a security alert and for forwarding to a security node in the OVO environment. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of, actions in response to detecting requests for unauthorized actions. At this point, the actions contained in the message from an unauthorized proxy have been disabled, and flowchart 500 proceeds to step 526 where the message is returned to the message stream interface. Steps 503-508 may be expressed using the following exemplary pseudo-code:

```
  If((msg generating node !=msg source node) &&
msg generating node !=pre-configured trusted proxy node))
  {
  //If possible set OPC_DATA_SENDER_ADDR_MISMATCH &
  //OPC_DATA_AUTHETICATION_FAILED flags in the
  //OPCDATA_DATA_INFO field.
  //alter message text to
  //“checkrmtactn: SPOOFED MESSAGE from NODE:
  <originating host ip>”
  //alter message severity to MAJOR
  //alter message group to IDSAlert
  //prepend to existing annotation, original message text to the message
    if(AACTION_CALL != null) //i.e. if auto-action string set
```

| | |
|---|---|
| { | |
| | //append to message text “; DISCARDED ACTION: <action> |
| | //FOR NODE: <action node i.e. AACTION_NODE>”. |
| | //If flags in the OPCDATA_DAT_INFO field can't be set, |
| | // then set the auto action string to “”, and append to existing |
| | // annotation, the auto action & action node. |
| } | //end of aaction check |

if (OPACTION_CALL != null) // i.e. if operator-init action string set

| | |
|---|---|
| { | |
| | //append to message text “; DISCARDED ACTION: <action> |
| | //FOR NODE: <action node i.e. OPACTION_NODE>”. |
| | //If flags in the OPCDATA_DAT_INFO field can't be set, |
| | //then set the operator-init action string to “”, and append to |
| | //existing annotation, the operator-init action & action node. |
| } | //end of opaction check |
| } | //end of msg generating node & msg source node check |

Referring now to step 509 of flowchart 500, a logical operation is performed to determine whether an action is being requested. As described above, the message proceeds to step 509 only if it is not a spoofed message and is either from an authorized proxy node or if the message is a non-proxy message. At step 509, if it is determined that no actions are being requested by the message, flowchart 500 proceeds to step 526 where the message is returned to the message stream interface. However, if an action is being requested in the message, flowchart 500 proceeds to step 510.

At step 510 a logical operation is performed to determine whether the generating node is a trusted node. In embodiments of the present invention, server 450 is the only trusted node in the OVO environment. This is because it can not be assumed that the agent templates at any of the client nodes have not been manually reconfigured by a user. Furthermore, in a multi-trust domain architecture, the message from an agent to server 450 or from OVO server 450 to an agent may pass through a different and potentially lower trust domain. Thus, in embodiments of the present invention, if the message is not generated from a trusted node, flowchart 500 proceeds to step 512. If the generating node is a trusted node, flowchart 500 proceeds to step 520. Steps 509 and 510 may be expressed using the following exemplary pseudo-code:

```
else
{
        // If not spoofed, check if incoming message has any action
            configured
if(AACTION_CALL != null | | OPACTION_CALL !=null)
        // i.e. if action string set
{
        //Check to see if the action is from Managed Node (Untrusted
        // node) to OVO server system (trusted)
if(msg generating node != OVO management server)
```

At step 511, a message that has been identified as a spoofed message is disabled. As described above, if a message is spoofed, no further action will be taken upon actions requested in the message. In implementations of the OVO environment, a spoofed message is automatically disabled in a manner similar to that discussed in steps 505-508. That is, data is appended to the message marking it as a spoofed message and that automatically initiates a security alert. Additionally, data is appended to the message so that it is automatically routed to an IDS server. Additionally, all automatic and operator initiated actions are disabled by appending data to the message that prevents the action from being performed. In embodiments of the present invention, the generating node may be isolated from the OVO environment by routing communications around that node. Step 511 may be expressed using the following exemplary pseudo-code:

| | |
|---|---|
| else | |
| { | |
| | //alter message text to |
| | //“checkrmtactn: SPOOFED MESSAGE from NODE: |
| | // <originating hostip> |
| | //prepend to existing annotation, original message text to the |
| | message |
| | //alter message severity to MAJOR |
| | //alter message group to IDSAlert |
| } | //end of authentication check else |
| | //Write back to MSI. |

Referring now to step 512 of FIG. 5B, a logical operation is performed to determine whether an automatic action is being requested. The steps performed in FIG. 5B pertain to a message that has been generated for a non-trusted agent. At step 512, if there is no automatic action requested in the message, flowchart 500 proceeds to step 516. If an automatic action is requested, flowchart 500 proceeds to step 513.

At step 513, a logical operation is performed to determine whether the action node is trusted. In other words is the action to be performed upon another client node in the OVO environment, or upon the OVO server. In embodiments of the present invention, no action can be generated by one untrusted node that is to be performed by the agent of another untrusted node. Access control software 460 determines that the action node is another untrusted node, the action will be blocked. Thus, at step 513, if the action node is another untrusted node, flowchart 500 proceeds to step 527 where all actions between two untrusted nodes are prevented from occurring. While the present invention recites blocking all actions between two untrusted nodes, configuration file 462 can be configured to allow, for example, specific authorized actions between specific untrusted nodes in other implementations of the present invention. If the action node is a trusted node (e.g., OVO server 450) flowchart 500 proceeds to step 514.

At step 514 a logical operation is performed to determine whether the action being requested is authorized. The configuration file of access control software is compared with the requested action to determine whether it is an authorized action. If the requested action is an authorized action, flowchart 500 proceeds to step 516. If the requested action is not an authorized action, flowchart 500 proceeds to step 515.

At step 515 the automatic action is prevented from occurring. As described above in the discussion of step 506, the message is appended with data that disables the automatic action and prevents it from being acted upon by the agent of the action node. Additionally, the message has been appended with data that automatically initiates a security alert and that routes the message to an IDS server. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of actions in response to detecting requests for unauthorized actions. At this point, flowchart 500 proceeds to step 516.

At step 516 a logical operation is performed to determine whether the message requests an operator initiated action. If no operator initiated action is being requested, flowchart 500 proceeds to step 526 where the message is returned to the message stream interface. That means that the message either contains no action calls, either automatic or operator initiated, or that unauthorized automatic actions have been disabled and there are no operator initiated actions being requested. Additionally, the message has been appended with data that automatically initiates a security alert and that routes the message to an IDS server. If there is an operator initiated action being requested, flowchart 500 proceeds to step 517.

At step 517 a logical operation is performed to determine whether the action node is a trusted node. If the action node, on which the action is to be performed, is not a trusted node, flowchart 500 proceeds to step 530. In embodiments of the present invention, local operator initiated actions are first routed to the OVO server and then back to the agent that generated the action. In the embodiment of FIG. 5, local operator initiated actions are allowed and therefore, flowchart 500 does not proceed to step 527 where all actions between two untrusted nodes are blocked. While the present invention recites blocking all actions between two untrusted nodes, configuration file 462 can be configured to allow, for example, specific authorized actions between specific untrusted nodes in other implementations of the present invention. Instead, at step 530 a logical operation is performed to determine whether the requested action is to be performed upon the generating node. If the action is being performed upon the node that generated the message, the action is permitted and flowchart 500 proceeds to step 526 where the message is returned back to the message stream interface. Step 530 may be expressed using the following exemplary pseudo-code:

else

{
if(OPACTION_NODE == msg generating node)
{

| | |
|---|---|
| | //allow ALL operator-initiated actions from the Managed |
| | //node (Untrusted) that are initiated on its own self |
| } | |
| else | |
| { | |
| | //Block all actions directed at hosts other that OVO |
| | //Management server from the Managed node |
| | (Untrusted) |
| | //alter message text to |
| | //“checkrmtactn: BLOCKED UNAUTHORIZED ACTION: |
| | <action> |
| | //from NODE: <message generating node name> |
| | //onto NODE: <action node>”. |
| | //prepend to existing annotation, original message text to |
| | the message |
| | //Append to existing annotation, auto &/or operator-init |
| | //action string, & action node |
| | //set auto &/or operator-init action string to “” |
| | //alter message severity to MAJOR |
| | //alter message group to IDSAlert |
| } | //end of OPACTION_NODE check with msg generating |
| | node else |
| } | //end of OPACTION_NODE check with OVO mgmt server else |
| } | //end of OPACTION_CALL check |
| } | //end of msg generating node check |

Referring again to step 517, if the operator initiated action is to be performed upon a untrusted node that did not generate the message, flowchart 500 proceeds to step 527 where all actions between two untrusted nodes are blocked. While the present invention recites blocking all actions between two untrusted nodes, configuration file 462 can be configured to allow, for example, specific authorized actions between specific untrusted nodes in other implementations of the present invention. Referring again to step 517, if the action node is trusted (e.g., the OVO server), flowchart 500 proceeds to step 518.

At step 518 a logical operation is performed to determine whether the operator initiated action is allowed. Access control software 460 compares the requested action with the configuration file to determine whether the requested action is on the list of allowed actions. If the requested action is allowed, flowchart 500 proceeds to step 526 where the message is returned to the message stream interface. If the requested action is not allowed, flowchart 500 proceeds to step 519.

At step 519 the operator initiated action is prevented from occurring. As described above in the discussion of step 507, the message is appended with data that disables the operator initiated action and prevents it from being acted upon by the agent of the action node. At this point, flowchart 500 proceeds to step 526 where the message is returned to the message stream interface. The message at this point may contain a blocked automatic action and/or a blocked operator initiated action. Additionally, the message has been appended with data that automatically initiates a security alert and that routes the message to an IDS server. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of actions in response to detecting requests for unauthorized actions.

At this point access control software 460 has identified spoofed messages, disabled them, initiated a security alert, and routed the messages to an IDS server. Access control software has also identified unauthorized proxy messages, disabled them, initiated a security alert, and routed the messages to an IDS server. Access control software 460 has processed messages from untrusted nodes, disabled unauthorized actions, initiated security alerts on those messages, and routed them to an IDS server. Furthermore, access control software 460 has identified messages from untrusted nodes that invoke authorized actions and returned them to the message stream interface so that the actions can be performed. Steps 512-519 may be expressed using the following exemplary pseudo-code:

if(AACTION_CALL != null)
{
if(AACTION_NODE == OVO management server)
{

//refer to pre-defined set of auto-action.

if(action doesn't belong to predefined set of auto-actions from
Managed nodes
(Untrusted) to OVO Management server (trusted))
{

| | //alter message text to |
|---|---|
| | //“checkrmtactn: BLOCKED UNAUTHORIZED ACTION: |
| | <action> |
| | //from NODE : <message generating node name> |
| | //onto NODE: <action node i.e. AACTION_NODE>”. |
| | //prepend to existing annotation, original message text to |
| | the message |
| | //set auto action string to “” |
| | //alter message severity to MAJOR |
| | //alter message group to IDSAlert |
| } | //end of action check |
| } | //end of AACTION_NODE check |
| else | |
| { | |
| | //Block all actions directed at hosts other than OVO |
| | Management server (trusted) from the Managed nodes |
| | (Untrusted) |
| | //alter message text to |
| | //“checkrmtactn: BLOCKED UNAUTHORIZED ACTION: |
| | <action> |
| | //from NODE: <message generating node name> |
| | //onto NODE: <action node>”. |
| | //prepend to existing annotation, original message text to |
| | the message |
| | //Append to existing annotation, auto &/or operator-init |
| | //action string, & action node |
| | //set auto and/or operator-init action string to “” |
| | //alter message severity to MAJOR |
| | //alter message group to IDSAlert |
| } | //end of AACTION_NODE check else |
| } | //end of AACTION_CALL check |

if(OPACTION_CALL !=null)
{
if (OPACTION_NODE == OVO management server)
{

//refer to pre-defined set of operator-init actions.
if (action doesn't belong to predefined set of operator-init
actions from Managed node (Untrusted) to OVO Server
(Trusted))

{

| | //alter message text to |
|---|---|
| | //“checkrmtactn: BLOCKED UNAUTHORIZED ACTION: |
| | <action> |
| | //from NODE: <message generating node name> |
| | //onto NODE: <action node i.e. OPACTION_NODE>”. |
| | //prepend to existing annotation, original message text to |
| | the message |
| | //set operator-init action string to “” |
| | //alter message severity to MAJOR |
| | //alter message group to IDSAlert |
| | //NOTE: If the AACTION_CALL != null, then above |
| | //modifications for OPACTION_CALL will be appended, |
| | if required. |
| } | //end of action check |
| } | //end of OPACTION_NODE check with OVO mgmt server |

Referring now to step 520, a logical operation is performed to determine whether an automatic action is being requested. As was discussed above, a message is routed to step 520 if the generating node is a trusted node (e.g., the OVO server). If an automatic action is not being requested in the message, flowchart 500 proceeds to step 523. If an automatic action is being requested, flowchart 500 proceeds to step 521.

At step 521 a logical operation is performed to determine whether the automatic action being requested is allowed. Access control software 460 compares the requested action with the configuration file to determine whether the requested action is on the list of allowed actions. If the requested action is allowed, flowchart 500 proceeds to step 523. If the requested action is not allowed, flowchart 500 proceeds to step 522.

At step 522 the automatic action is prevented from occurring. As described above in the discussion of steps 506 and 515, the message is appended with data that disables the automatic action and prevents it from being acted upon by the agent of the action node. Additionally, the message has been appended with data that automatically initiates a security alert and that routes the message to an IDS server. At this point, flowchart 500 proceeds to step 523. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of actions in response to detecting requests for unauthorized actions.

At step 523 a logical operation is performed to determine whether an operator initiated action is being requested. If no operator initiated action is being requested, flowchart 500 proceeds to step 526 where the message is returned to the message steam interface. If an operator initiated action is being requested, flowchart 500 proceeds to step 524.

At step 524 a logical operation is performed to determine whether the requested action is allowed. Access control software 460 compares the requested action with its configuration file to determine whether the requested action is on its list of authorized actions. If the requested action is allowed, flowchart 500 proceeds to step 526 where the message is returned to the message stream interface. If the requested action is not authorized, flowchart 500 proceeds to step 525.

At step 525 the operator initiated action is prevented from occurring. As described above in the discussion of steps 507 and 519, the message is appended with data that disables the operator initiated action and prevents it from being acted upon by the agent of the action node. At this point, flowchart 500 proceeds to step 526 where the message is returned to the message stream interface. The message at this point may contain a blocked automatic action and/or a blocked operator initiated action. Additionally, the message has been appended with data that automatically initiates a security alert and that routes the message to an IDS server. In embodiments of the present invention, if an unauthorized action is requested, OVO server 450 may send a reconfigured set of agent templates to the node requesting unauthorized action. While the present embodiment recites these actions specifically, embodiments of the present invention can be configured to take a variety of actions in response to detecting requests for unauthorized actions. Steps 520-525 may be expressed using the following exemplary pseudo-code:

else

{

| | //Block all actions directed at hosts other that OVO Management |
|---|---|
| | //server from the Managed node (Untrusted) |
| | //alter message text to |
| | //“checkrmtactn: BLOCKED UNAUTHORIZED ACTION: |
| | <action> |
| | //from NODE: <message generating node name> |
| | //onto NODE: <action node>”. |
| | //prepend to existing annotation, original message text to the |
| | message |
| | //Append to existing annotation, auto &/or operator-init action |
| | //string, & action node |
| | //set auto &/or operator-init action string to “” |
| | //alter message severity to MAJOR |
| | //alter message group to IDSAlert |
| } | //end of OPACTION_NODE check with msg generating node |
| | else |
| } | //end of OPACTION_NODE check with OVO mgmt server else |
| } | //end of OPACTION_CALL check |
| } | //end of msg generating node check |

Referring again to FIG. 3, at step 330 the action is prevented from occurring. In the above discussion of flowchart 500, when access control software 460 determines that an action is not permitted, the action is disabled to prevent it from occurring.

In response to detecting a request for an unauthorized action, access control software 460 can be configured to initiate a variety of actions. The configured action can be a simple modification of the message text as well as altering the message severity. Furthermore, the message can be automatically redirected to the security or IDSAlert message group. Alternatively, a Simple Network Management Protocol (SNMP) trap or a syslog message in a specific format may be configured. Notifications in the form of pager or e-mail alerts can be configured or the message generating node can be isolated from the OVO environment. While the present embodiment recites these actions specifically, embodiments of the present invention can be configured to take a variety of actions in response to detecting requests for unauthorized actions. Additionally access control software 460 can be implemented as an OVO aware IDS probe integrated into an IDS network by configuring it to notify the IDS server of any instance of an attempt to initiate unauthorized remote action from a managed node or any attempt to spoof an OVO message from a managed node.

The preferred embodiment of the present invention, a method and system for preventing unauthorized action in an Application and Network Management software environment, is thus described. While the present invention has been described in particular embodiments, it should be appreciated that the present invention should not be construed as limited by such embodiments, but rather construed according to the following claims.

What is claimed is:

1. In an Application and Network Management software (ANMS) environment, a method for preventing an unauthorized action comprising:
receiving a message in said ANMS environment from an ANMS sending node comprising a request for an action;
determining that said action is not permitted in said ANMS environment; and
preventing said action from occurring in said ANMS environment.

2. The method as recited in claim 1, wherein said determining comprises:
determining that said ANMS sending node is not permitted to request said action.

3. The method as recited in claim 2, wherein said determining further comprises:
comparing said ANMS sending node with a list of authorized ANMS sending nodes; and
determining that said ANMS sending node is not on said list of ANMS authorized sending nodes.

4. The method as recited in claim 2, wherein said determining further comprises:
comparing said action with a list of authorized actions for said ANMS sending node; and
determining that said ANMS sending node is not permitted to request said action

5. The method as recited in claim 4 further comprising:
automatically sending said list of authorized actions to said sending node.

6. The method as recited in claim 1, wherein said determining comprises:
determining that said action is not permitted upon an ANMS receiving node upon which said action is to be performed.

7. The method as recited in claim 6, wherein said determining further comprises:
comparing said action with a list of authorized actions for said ANMS receiving node; and
determining that said action is not permitted upon said ANMS receiving node.

8. The method as recited in claim 1 wherein said preventing further comprises:
altering said message to prevent said action from occurring in said ANMS environment.

9. The method as recited in claim 8, further comprising:
generating a security alert wherein said altering indicates that said action is not permitted in said ANMS environment.

10. The method as recited in claim 9, wherein said generating a security alert comprises:
automatically redirecting said message to a security node in response to said determining.

11. The method as recited in claim 9, further comprising:
automatically isolating said sending node from said ANMS environment in response to said security alert.

12. The method as recited in claim 9 wherein said action is selected from the group consisting of an automatic action and an operator initiated action.

13. A computer-usable medium having computer-readable program code embodied therein for causing a computer system to perform the steps of:
accessing a request for an action received from an ANMS sending node;
determining that said action is not permitted; and
preventing said action from occurring.

14. The computer-usable medium of claim 13, wherein said determining comprises:
determining that said ANMS sending node is not permitted to request said action.

15. The computer-usable medium of claim 14, wherein said determining further comprises:
comparing said ANMS sending node with a configuration file listing a plurality of authorized ANMS sending nodes; and
determining that said ANMS sending node is not listed on said configuration file.

16. The computer-usable medium of claim 14, wherein said determining further comprises:
comparing said action with a configuration file wherein a plurality of authorized actions for said ANMS sending node is listed; and
determining that said action is not listed in said configuration file.

17. The computer-usable medium of claim 16 further comprising:
automatically sending said list of authorized actions to said sending node in response to determining that said action is not listed in said configuration file.

18. The computer-usable medium of claim 13, wherein said determining comprises:
determining that said action is not permitted upon an ANMS receiving node upon which said action is to be performed.

19. The computer-usable medium of claim 18, wherein said determining further comprises:
comparing said action with a configuration file listing authorized actions for said ANMS receiving node; and
determining that said action is not in listed in said configuration file.

20. The computer-usable medium of claim 13 wherein said preventing further comprises:
altering said message to prevent said action from occurring.

21. The computer-usable medium of claim 20, further comprising:
generating a security alert wherein said altering indicates that said action is not permitted.

22. The computer-usable medium of claim 21, wherein said generating a security alert further comprises:
automatically redirecting said message to a security node in response to said determining.

23. The computer-usable medium of claim 21, further comprising:
automatically preventing said sending node from sending a second request in response to generating said security alert.

24. The computer-usable medium of claim 13 wherein said action is selected from the group consisting of an automatic action and an operator initiated action.

25. An Application and Network Management software (ANMS) system comprising:
a client node;
a server node;
a software agent coupled with said server node; and
an ANMS access control component coupled with said server node and for preventing an unauthorized action in said ANMS system, wherein said ANMS access control component accesses a request from an sending node for an action and prevents said action from occurring in said ANMS system upon determining that said action is not permitted.

26. The system of claim 25, wherein said ANMS access control component comprises:
a configuration for said ANMS system wherein a plurality of permitted actions are listed and wherein said ANMS access control component utilizes said configuration to determine that said action is not permitted.

27. The system of claim 26, wherein ANMS access control component determines that said sending node is not listed on said configuration for said ANMS system.

28. The system of claim 26, wherein said ANMS access control component determines that said action is not listed on said configuration for said ANMS system.

29. The system of claim 28, wherein said ANMS access control component automatically sends said configuration to said sending node in response to determining that said action is not listed on said configuration for said ANMS system.

30. The system of claim 26, wherein said ANMS access control component uses said configuration for said ANMS system to determine that said action is not permitted upon an ANMS receiving node upon which said action is to be performed.

31. The system of claim 26, wherein said ANMS access control component further comprises:
a comparitor for comparing said action with said configuration for said ANMS system and for determining that said action is not permitted upon said ANMS receiving node.

32. The system of claim 31, wherein said ANMS access control component further comprises:
a monitoring component for detecting unauthorized access to said configuration and for preventing said action when unauthorized access to said configuration has been detected.

33. The system of claim 32, wherein said monitoring component is further for monitoring the operation of said comparitor and for preventing said action when said comparitor is unavailable.

34. The system of claim 26 wherein said ANMS access control component alters a message conveying said request to prevent said action from occurring.

35. The system of claim 34 wherein said ANMS access control component automatically generates a security alert in response to determining that said action is not permitted.

36. The system of claim 35, wherein ANMS access control component automatically redirects said message to a security node in response to determining that said action is not permitted.

37. The system of claim 35, wherein said security alert initiates automatically isolating said sending node from said ANMS system in response to said security alert.

38. The system of claim 35 wherein said action is selected from the group consisting of an automatic action and an operator initiated action.

39. The system of claim 25, wherein said sending node comprises an ANMS client node.

40. The system of claim 25, wherein said sending node comprises an ANMS server node.
